(19) United States
(12) Patent Application Publication
(10) Pub. No.: US 2002/0116249 A1
(43) Pub. Date: Aug. 22, 2002

(54) On-line method and apparatus for analyzing transactional and demographic data

(76) Inventors: Josh Ellinger, Austin, TX (US); Frank Smejkal, Austin, TX (US); Stephen Piche, Austin, TX (US)

Correspondence Address: HOWISON, THOMA & ARNOTT, L.L.P, P.O. BOX 741715, DALLAS, TX, 75374-1715, US

(21) Appl. No.: 09/748,074

(22) Filed: Dec. 22, 2000

(51) Int. Cl. G06F 17/60

(52) U.S. Cl. 705/10

(57) ABSTRACT

An on-line method and apparatus for analyzing transactional and demographic data. A method for tracking analytical information acquired during consumer transactions includes the steps of conducting a commercial transaction between a customer and a vendor, and then creating a record of each of the transactions conducted between the customer and the vendor. The created record of the commercial transaction is then stored in a vendor transaction database. In a retrieval operation, the created record is retrieved from the vendor transaction database, and then information relating to information retrieved from the vendor transaction database is retrieved from an enhancing database. The combination of the retrieved records from the vendor transaction database and the retrieved information from the enhancing database is stored as aggregate data in an aggregate database in a relational manner. Thereafter, an analysis is performed on the aggregate data stored in the aggregate in accordance with a predetermined analytical algorithm to provide an analytical result.

### BACKGROUND OF THE INVENTION

In the current commercial environment, most vendors deal electronically with a large customer database. Each of these customers enters into an individual transaction with the vendor over a networked system such as the global communication network, typically referred to as the “Internet.” Each of these transactions is typically recorded at the vendor's site with the vendor extracting and storing a large amount of data associated with this transaction. This data can be in the form of user profile information, transaction information, etc. However, the vendor is typically limited to the information that is retrieved from the customers themselves.

In some commercial transactions, the vendor's desire to utilize information regarding a customer, their purchasing habits and overall trends to customize the interface to that user. The goal is to provide a more competitive transaction to the industry to enhance profits through increased sales and/or reduced overhead. In order to facilitate the commercial transaction, vendors typically desire to have information about various trends in these commercial transactions. Outside services have typically provided analysis tools for allowing a vendor to analyze the information in their database and perform some type of statistical analysis on the data to provide information about various trends that exist from this data. One of the difficulties that arises in providing such a service is having access to a large database for a vendor on a real time basis. The reason for this is that there are a large number of transactions occurring on a rapid basis, i.e., the database is accruing data and growing. This presents a challenge to a statistical analysis program in that it must either retrieve each record as the record is created or the record must be “pushed” from the database to the desired analysis location for the statistical analysis.

### SUMMARY OF THE INVENTION

The present invention disclosed and claimed herein, in one aspect thereof, comprises a method for tracking analytical information acquired during consumer transactions. A commercial transaction is conducted between a customer and a vendor, and a record created of each of the transactions conducted between the customer and the vendor. The created record of the commercial transaction is then stored in a vendor transaction database. In a retrieval operation, the created record is retrieved from the vendor transaction database, and then information relating to information retrieved from the vendor transaction database is retrieved from an enhancing database. The combination of the retrieved records from the vendor transaction database and the retrieved information from the enhancing database is stored as aggregate data in an aggregate database in a relational manner. Thereafter, an analysis is performed on the aggregate data stored in the aggregate in accordance with a predetermined analytical algorithm to provide an analytical result.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an overall diagrammatic review of the statistical analysis system of the present disclosure;

FIG. 2 illustrates a diagrammatic view of the statistical transaction utilizing the enhancing database;

FIG. 3 illustrates a flow chart depicting the transaction operation at a vendor;

FIG. 4 illustrates a flow chart depicting the push operation where data is pushed to the analysis site;

FIG. 5 illustrates the “pull” operation wherein data is requested by the analysis site;

FIG. 6 illustrates a flow chart depicting the operation of processing the data at the statistical analysis site;

FIG. 7 illustrates a flow chart depicting the operation of processing a request at the vendor database;

FIG. 8 illustrates a flow chart depicting the operation wherein the process is modified at vendor web site;

FIG. 9 illustrates a flow chart depicting the messaging operation;

FIG. 10 illustrates a diagrammatic view of multiple aggregate databases;

FIG. 11 illustrates a diagrammatic view of the statistical evaluation engine; and

FIG. 12 illustrates a block diagram of the fetch operation.

FIG. 13 illustrates a more detailed diagrammatic view of the manner in which the aggregate database operates;

FIG. 14 illustrates an example of the embodiment of FIG. 13;

FIG. 15 illustrates a simplified diagrammatic view incorporating PDA;

FIGS. 16-21 illustrate screen shots for the interactive user interface accessible by the user; and

FIG. 22 illustrates a frontal view of a PDA.

### DETAILED DESCRIPTION OF THE INVENTION

Referring now to FIG. 1, there is illustrated a diagrammatic view of the overall system of the present disclosure for conducting a commercial transaction, updating a database at a vendor site and analyzing these statistics associated with the database and the underlying transactions. The transaction typically will occur between a customer base 102 and a vendor 104. A customer base 102 is comprised of a plurality of customers 106 depicted as customer C1, C2, C3 . . . , CN. Each of the customers is represented as being connected to the vendor 104 through a global communication network (GCN) 108, typically referred to as the “Internet.” Vendor 104 is also connected to the GCN 108. Although not illustrated, each of the customers 106 is interfaced through the GCN via some type of communication device. This communication device typically comprises a personal computer that is connected to an Internet Service Provider (ISP) via a public telephone network. The ISP typically has a data link to the backbone of the GCN 108 which carries data at relatively high data rates. This is a well known network. The vendor 104, similarly, is interfaced with the GCN 108 through a typically more sophisticated interface. Typically, the vendor 104 is directly connected to the backbone of the GCN 108 or close thereto. More typically, the vendor 104 has a plurality of server connections that allow interface through the GCN 108 to handle a substantially large amount of traffic.

The vendor 104 has connected thereto a database 110, which database 110 stores therein records of all transactions associated with the customer vendor interface, as will be described hereinbelow. As is conventional in such a commercial transaction, a customer 106 will interface the vendor's location on the network and, once connected, will then enter into a commercial transaction. This commercial transaction can take many forms. A typical form would be to enter profile information for the user upon a first access, receive some type of identifier for future transactions, and then conduct the commerce transaction. This commerce transaction could involve purchasing something over the GCN 108 to be delivered from a warehouse 112, for example, through a delivery service 114 to the requesting one of the customers 106 in the customer base 102. This transaction would then be entered into database 110 as a record, either new or updated. This record could include such things as the user profile, information on the user's transactions to date, etc.

In conjunction with the vendor's transaction, there is also provided an analysis site 118 that is interfaced with the GCN 108 in a similar manner to the interface between the customer 106 and the vendor 104. This can be a high speed connection or any other type of connection that allows information to be transferred over the GCN 108. The analysis site 118, as will be described in more detail hereinbelow, is operable to obtain information from the vendor 104, the vendor 104 being a customer of the service provider associated with the analysis site 118. This information is utilized to create an aggregate statistical database 120 which can be utilized for providing statistical information about the retrieved vendor data to the vendor 104. There is also provided at the analysis site 118 certain vendor configuration information in a storage location 122, which vendor configuration information is manipulatable by the vendor 104 through the GCN 108. Additionally, there are provided various messages in a message template 124 that allow the vendor to have a certain interface with the analysis site 118 and the statistics that are provided. The analysis site 118, as will be described in more detail hereinbelow, is operable to collect the data, perform the statistical analysis on the data in conjunction with the vendor configuration information and provide certain responses, as defined by the message template 124. This operation will be discussed in much more detail hereinbelow. In addition to the analysis site 118 collecting data and storing aggregate statistics in the database 120 based on collected data from the vendor 104, the analysis site 118 is also operable to enhance this data and statistical evaluation thereof with information from an enhancing database 130 on the GCN 108. This provides an additional enhanced aspect to the aggregate statistics 120. A monitoring function is provided through a monitor site 132, which allows a user, be it the vendor or other authorized user, to analyze these aggregate statistics 120 in accordance with vendor information provided in the vendor configuration block 122. In addition, messages can be sent to the monitor 132 to provide information regarding these statistics 120.

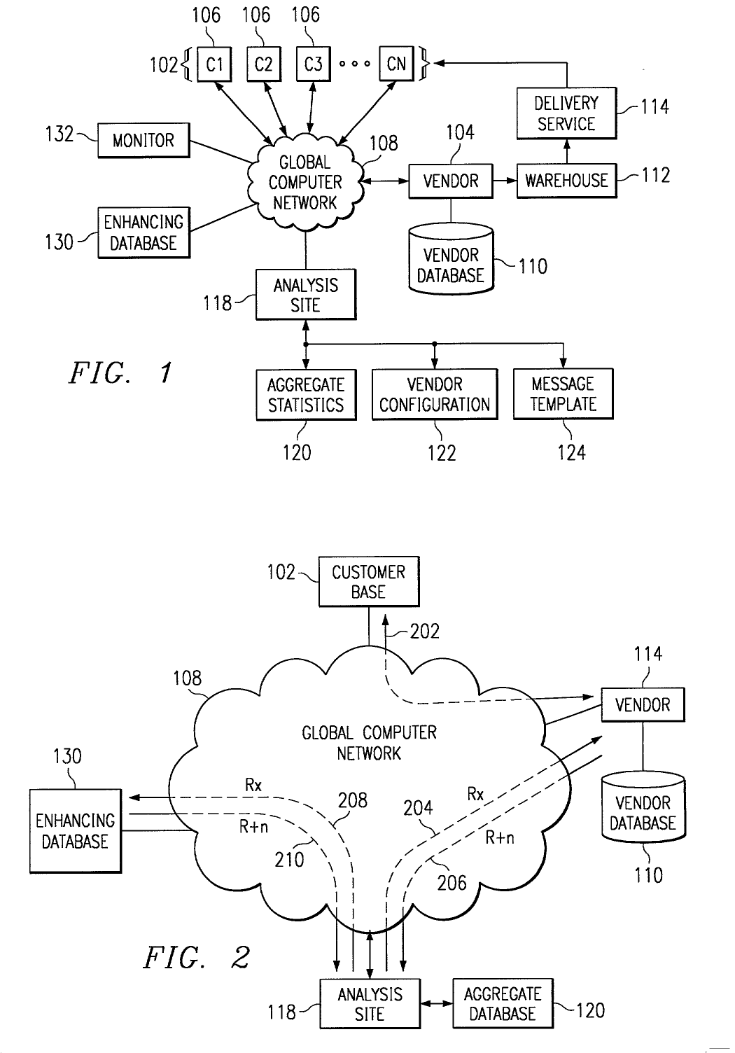

Referring now to FIG. 2, there is illustrated a diagrammatic view of the processes involved in interfacing between the vendor 104 and the customer base 102 and also between the vendor 104 and the analysis site 118. In an operation, the customer base 102 establishes a connection with the vendor 114, as indicated by a double arrow connection line 202. This, as described hereinabove, allows each customer in the customer base 102 to interface with the vendor 114 for the particular commercial transaction associated with that connection. It should be understood that many different types of commercial transaction can be undertaken by different customers and even by a single customer. Once the transaction has occurred, it is stored as a record in the vendor database 110. After this occurs, the vendor database 110 then contains information that is not contained in the aggregate database 120 associated with the analysis site 118.

In order to update the aggregate database 120, a connection must be made between the vendor 114 and the analysis site 118. In the preferred disclosure, this operation is a “PULL” operation. In such an operation, the analysis site 118 contacts the vendor, i.e., establishes a communication link, and then sends a request thereto. This request indicated by a transmission arrow 204 that indicates information being sent to the vendor 114. Once the vendor 114 receives the request, the vendor 114 takes the appropriate requested action, queries its database 110, and then assembles the retrieved data in the appropriate packet. This packet of information is then sent back to the analysis site 118 via a return path 206 which is opted to contain an XML data stream. The XML data stream is then returned on the return path 206 as a response to the request. The request can be in any form, with a typical request being a range of records, such that the request is fairly short. The vendor 114 typically will run some type of scripting language such as Javascript to extract the records which is provided by the service provider at the analysis site 118 to the vendor 114, the vendor 114 being a customer of the provider. Once the request is received, a large number of records could be assembled and forwarded back to the analysis site 118 in one large block or in a number of smaller blocks. This could be via other paths also, depending upon the bandwidth of the front end of the vendor 114.

Once the data is received by the analysis site 118, it is then processed to determine certain statistics in accordance with predetermined configurations provided by the vendor 114, i.e., the vendor 114 determines how the statistical analysis is performed within certain constraints. During this statistical evaluation of the data, this data is enhanced with information from the enhancing database 130. Therefore, during this statistical analysis, the analysis site 118 contacts the enhancing database 130 via a request sent by a request line 208 and return data received on a return link 210. In the present disclosure, this enhancing database is one that provides demographic data. Therefore, the information forwarded to the enhancing database 130 is information regarding a particular customer record, i.e., an individual's name and address, for example. The enhancing database 130 provides this information back to the analysis site 118. It should be understood that this information provided by the enhancing database 130 can be any type of information other than demographic data, and inclusive thereof. This information could even be other data from the vendor that was determined during the statistical analysis to be required. It is noted that the enhancing database provides additional information to that forwarded to the analysis site 118 in response to the request sent thereto. For example, it could be determined by the analysis site 118 during evaluation of the data that insufficient information was available to perform the particular statistical analysis required by the vendor 114. Thus, additional information would be required by the analysis site 118 during statistical evaluation of the requested and received data from the vendor 114 in this scenario.

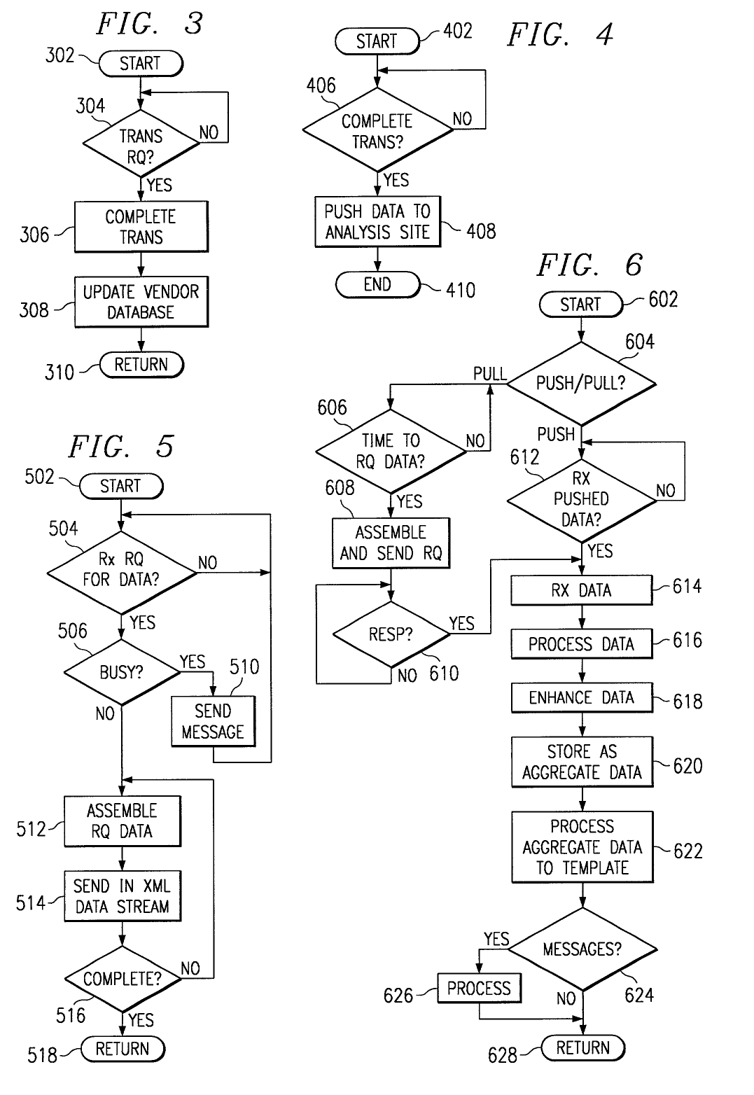

Referring now to FIG. 3, there is illustrated a flow chart depicting the operation wherein a customer 106 enters into a transaction with the vendor 114. The program is initiated at a block 302, and then proceeds to a decision block 304 to determine if a request for transaction has been received from the customer 106, i.e., this indicating that a customer has accessed their web server. This access is typically done by sending a request packet from the customer's location to the vendor URL. This request packet will contain the destination URL of the vendor 114, identification information from the user, i.e., the customer 106, and routing information thereto. The URL typically has some association with the commercial transaction being desired. If this is received, the program will flow along the “Y” path to function block 306. Otherwise, it will flow along the “N” path back to the input of decision block 304. Once the transaction has been initiated via a request from the customer 106, the function block 306 indicates that the operation wherein the transaction is completed. As described hereinabove, this transaction could provide multiple data transfers between the customer 106 and the vendor 114 transferring many different types of information such as user's request, part numbers, product numbers and even some type of bar code information that was extracted from an article of commerce. There may even be credit card information that is exchanged. Any type of commercial transaction is anticipated for the present disclosure.

Once the transaction is complete, the program will flow into function block 308 wherein the vendor database 110 will be updated with a new record or even updating an old record. However, once updated, this record will have a new transaction data indicating that the record is an updated record. Once updated, the program will flow to a return block 310.

Referring now to FIG. 4, there is illustrated a flow chart depicting the operation between a vendor 114 and the analysis site 118 during a “PUSH” operation. Although the primary aspect of the present disclosure is that associated with the “Pull” technique, it is anticipated that a “Push” technique could be utilized. In the “Push” technique, the vendor 114 will “Push” the information to the analysis site 118 under the control of the vendor upon the occurrence of some conditional operation, such as the update of the record. The program is initiated at a block 402 then proceeds to decision block 406. In decision block 406, the condition is the completion of a transaction. If not completed, the program will flow along the “N” path back to the input. Once completed, the program will flow along the “Y” path to a function block 408 to push the data to the analysis site 118. This is an operation whereby a link is first established by sending packets of data to the analysis site 118 and once established, then the new or updated record will be sent to the analysis site 118. Of course, this does not need to occur upon each record that is updated, but rather, could be over a certain date range and at a certain time. Once the data is sent to the analysis site 118, the program flows to an End block 410.

Referring now to FIG. 5, there is illustrated a flow chart depicting the operation at the vendor 114 during the “Pull” operation. The program is initiated at a block 502 and then proceeds to decision block 504 to determine if a request for data has been received from the analysis site 118. If not, the program will flow back into the input of decision block 504. If so, the program will flow along the “Y” path to decision block 506 which determines if the system is busy. This is a general aspect that requires further processing and determines whether the request should be handled at the present time. This is an operation under the control of the vendor 114 to allow the vendor to control access to their servers. This will be described in more detail hereinbelow. However, if these busy conditions are determined to exist, i.e., the features activated by the vendor 114 and the condition associated therewith exists, the program will flow along the “Y” path from decision block 506 to a function block 510. Function block 510 will send a message back to the analysis site 118 that information will be sent at a later time with possibly only a certain amount of information being sent. If only a certain amount of information is being sent, this message will be sent, and, although not illustrated in the flow chart, the program will flow back to the output of the decision block 506. If the system is merely busy and it is to wait for a later time, this is then logged into the system and decision block 506 will proceed from the output thereof at a later time. Once this occurs, the program will return to the input of decision block 504.

Once it is determined that transmission of data is to be effected, either all of the data or a partial amount of data or even delayed data at a later time, the program will flow from decision block 506 to a function block 512 to assemble the requested data at the vendor site 114. This involves running a script that was provided to the vendor site 114 by the service provider of the analysis site 118 and querying the vendor database 110 for the appropriate information. This information is received, formatted in an XML data stream. The program then proceeds to a function block 514 to send the XML data stream to the analysis site 118, utilizing conventional transfer protocols, such as TCP/IP. The program then flows to a decision block 516 to determine if the transfer of data is complete. If not, the program will flow along the “N” path back to the function block 512. If complete, the program will flow along the “Y” path to the block 518 to indicate that the transfer is complete, this being a return block.

Referring now to FIG. 6, there is illustrated a flow chart depicting the operation at the analysis site 118. The program is initiated at a function block 602 and then proceeds to a decision block 604 to determine if the operation is a Push or a Pull operation. If it is a Pull operation, this indicates that information is to be requested from the vendor site 114. If it is a Push operation, this indicates that data is being sent to the analysis site 118 from the vendor 114. If the operation proceeds along equal “Pull” path, the program will flow to a decision block 606 to determine if it is time to request data. This decision block 606 indicates time but it can also indicate a manual determination that information is to be requested or it can even indicate a conditional operation wherein a certain condition has been met either through a processing step at the analysis site 118 or through some other condition. If it is not time to request data for any of these reasons, the program will flow back to the input and await this condition. Once the condition has occurred, the program will flow from the decision block 606 along the “Y” path to a function block 608 to assemble and send the request to the vendor 114. The program will then flow to a decision block 610 to wait for the response from the vendor 114. The program would loop along the “N” path back to the input of decision block 610 with a time out provision provided until the response is received.

In a Push operation, the program will flow along the “Push” path from decision block 604 to a decision block 612 to determine if the Push data has been received. In this mode, the system would continually be waiting for data to be pushed thereto and would flow along the “N” path back to the input of decision block 612 until such data was received. Once this data has been received, the program will flow along the “Y” path to a function block 614 to receive the data transferred along the return path 206 from the vendor 114. This is also the point in the program that the decision block 610 would flow to a “Y” path therefrom. Neither the push or the pull operation, both operations would go to the function block 614.

Once the data is received, this data is first processed in a function block 616 for the purpose of adding to the aggregate database. In order to do this, the analysis site 118 would fetch the appropriate data from the enhancing database 130, as indicated by function block 618. This data would then be processed where it would actually be stored as aggregate data in a function block 620 and then this aggregate data would be processed via a statistical analysis thereof in accordance with the template provided by the vendor 114, as indicated by a function block 622. Once this statistical analysis has been performed, the program would flow to a decision block 624 to determine if any messages need to be sent as a result of this processing. If so, the program will flow along a “Y” path to process the messages, as will be described hereinbelow, indicated by function block 626, and flow to a Return block 628. If no messages were required, the program would flow thereto from decision block 624 along the “N” path therefrom.

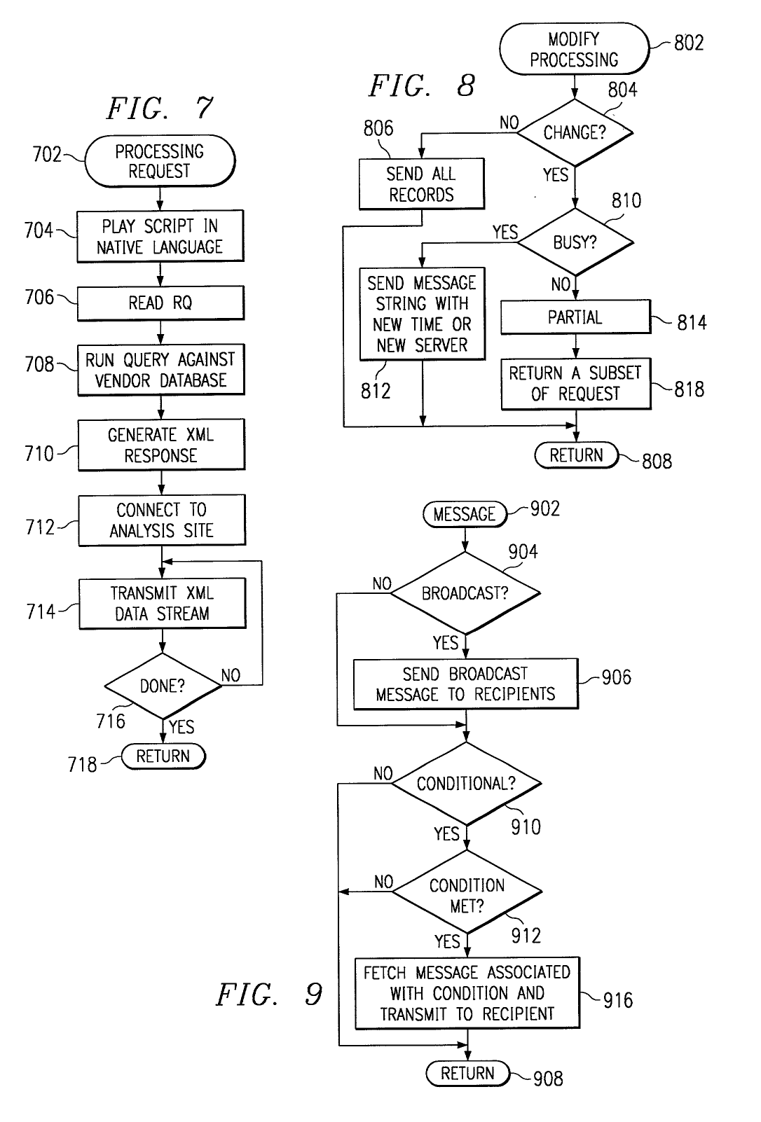

Referring now to FIG. 7, there is illustrated a flow chart depicting the operation of processing at the vendor site 114. The program is initiated at a block 702 and then proceeds to a function block 704 to play the script in the native language of the vendor site 114. Typically, there exists a plurality of database structures and database interface languages. The analysis site 118 need only provide a scripting language to the vendor 114 that allows the vendor 114 to receive the request in accordance with their database structure and then form the query for its associated database 110 to provide data in a desired format that would interface with the analysis site 118, this being an XML formatted data stream. Therefore, once the request is received, then this particular script need only be run.

The request is what is typically referred to as a “fetch” operation and this may actually be a time related operation. All that will be required is that the request indicates the records be provided in accordance within certain parameters or restrictions. For example, this could be a time related request indicating that the data records being sought are those associated with a time period extending from October 1^{st} through October 2^{nd} from a time of 12:00 p.m. on October 1^{st} through 5 p.m. on October 2^{ndl . This information is associated with the aggregate database 120 indicating that such data is being sought, indicating an incremental addition to the database. Once this request is read, as indicated by a function block 706, the program flows to a function block 708 to run a query against the vendor database 110. This will basically then assemble all the records that have been updated or new records entered into the database 110 and then formatted into XML format. This will typically be in the form of a plurality of orders. This, by way of example and not by way of limitation, would be as follows:}

<orders>

| | |
|---|---|
| <order | total = “$50”> |
| | <persons name = Smith> |
| | <product ID = xxxx> |
| | </order> |
| <order | total = “$25”> |
| | <persons name = Jones> |
| | <product ID = yyyy> |
| . | |
| . | |
| . | |

This XML response is indicated by a function block 710. Once the response has been assembled, the vendor web site 114 will connect to the analysis site, as indicated by function block 712 and then the information will be transmitted in the form of the XML data stream, as indicated by a function block 714. The program will flow to a decision block 716 to continue to determine if the data transfer is complete. If not, the program will loop back around along the “N” path until finished. Once complete, the program will flow to a return block 718 along a “Y” path.

Referring now to FIG. 8, there is illustrated a flow chart depicting the operation of modifying the processing, this indicated by the decision block 506 in FIG. 5, wherein the vendor has determined that certain processing transactions take priority with the servers associated therewith. This modified processing operation is initiated at a block 802 by vendor 114. The program will then flow to a decision block 804 to determine if the vendor desires to change the normal operation that is associated with a request, i.e., whether all records will be transferred. If no change is to be effected, the program will flow to a function block 806, wherein all records associated with the request will be transferred to the analysis site 118 and then the program will flow to a return block 808. However, if the vendor 114 has changed or modified the transfer of information, the program will flow along the “Y” path to a decision block 810 to determine if the system is “Busy.” This state indicates that the vendor is incurring a large deal of traffic due, for example, to it being the Christmas season or some other holiday season. Of course, there could be other things that result in this due to an unexpected heavy load of traffic and associated commercial transactions. In this situation, it would be desirable not to allow requests to be received and processed by the vendor servers. The program will then flow along the “Y' path to return a message to the analysis site 118, as indicated by a function block 812, that the request must be retransmitted at a later time or that the request must be transmitted to another server, or other appropriate action. The program will then flow to the return block 808. If, however, the busy flag had not been set, the program will flow to a function block 814 to indicate that only a partial transfer is to be effected. Although the analysis site 114 may have requested two days worth of records, only a subset of that information would be returned in this embodiment of the disclosure. In this operation, the vendor site 114 would return the data and indicate what portion of the records were returned such that the analysis site 114 could at a later time send another request for the remaining information. This subset of the request is then returned, as indicated by a function block 818 to the analysis site 118. Although only two modification operations are provided, any type of modification to the request could be provided for in this operation. In addition, a message could be sent to a software application. This message could be sent in XML format. The content of the message could cause a change in the execution of the software application. Thus, the messages, which can be triggered by business logic or rules, can automatically affect a software application.

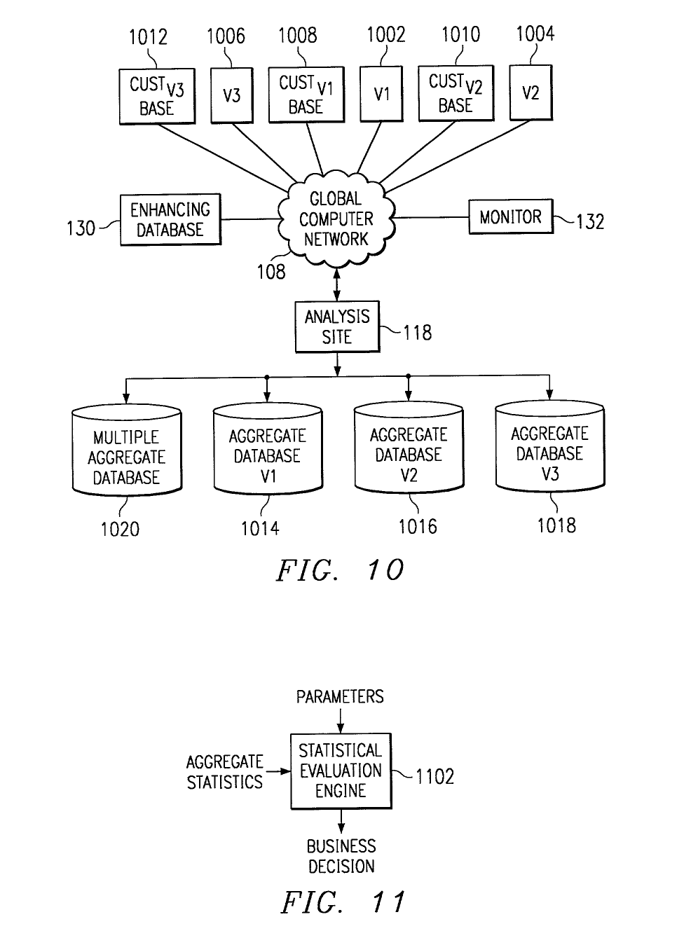

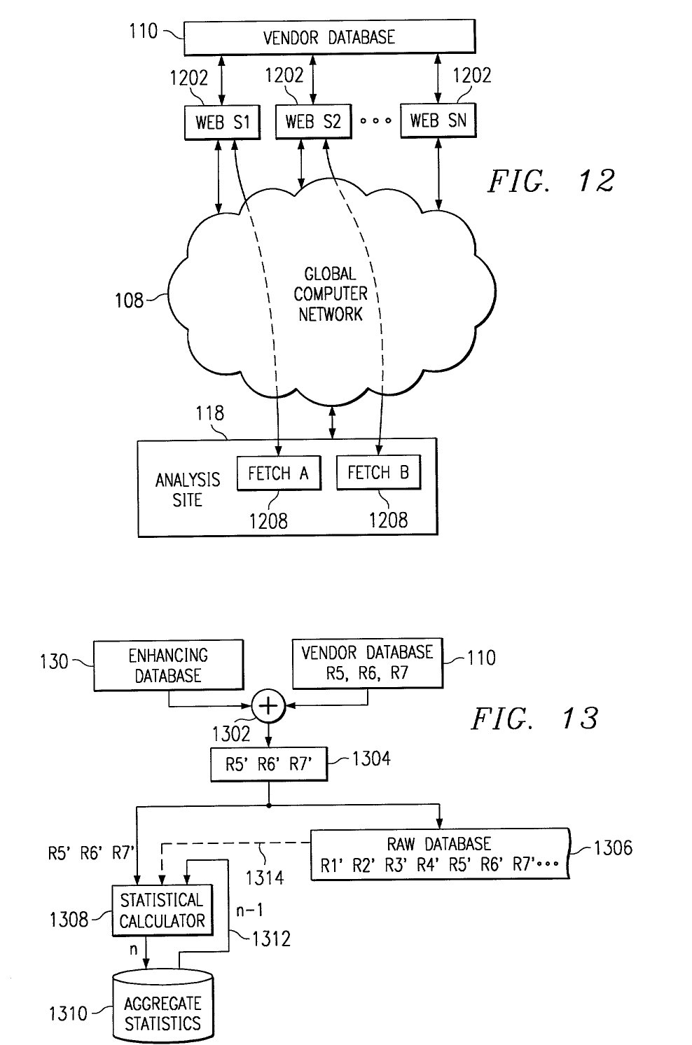

Referring now to FIG. 9, there is illustrated a flow chart depicting the operation of sending a message to any individual or site on the GCN 108 or to the vendor 114. The flow chart is initiated in block 902 and then proceeds to a decision block 904 to determine if this is to be a broadcast message. Of course, this flow chart is initiated whenever it is determined that a messaging feature has been selected. If it is a broadcast message, the program flows along a “Y” path to a function block 906 to send the broadcast message to the recipient(s) in accordance with a local table that is provided at the analysis site 118. This message transfer could be via the GCN 108 or it could be via voice mail messages, e-mails or any other manner of transmitting the message. Once forwarded, the program flows to a decision block 906, which is also the node in the flow chart to which the “N” path of decision block 904 flows.

The decision block 906 determines if a conditional messaging operation is set. If so, the program will flow on the “Y” path. If not, the program flows along an “N” path to a return block 908. However, if the conditional operation has been selected, the program will flow along the “Y” path to a decision block 912 to determine if the condition is met. If the condition has been met, this being a condition that has been input by the vendor 114 or is a condition that is inherent to the operating system at the analysis site 118, the program will flow along the “Y” path to the function block 916 to fetch the message associated with that condition then transmit it to the recipient(s), and then to the return block 908. Once the condition has not been met, the program flows along the “N” path to return block 908.

As an example of the messaging, consider that certain trends have been detected in the statistical analysis of the data. In this operation, the trend would exceed a certain threshold. If this threshold were exceeded, a message would be sent to the monitor location 132 via the GCN 108, or it could be sent via a wireless appliance, such as a pager, a cell phone with a wireless appliance protocol (WAP) feature, or any type of wireless appliance that could be interfaced thereto. This message would indicate to the recipient that the condition existed and that some action needed to be taken. In addition, the actual action to be taken could be provided to that recipient. As an example, if it were indicated that the traffic that existed between a certain period of time of the day were associated with a certain region of the country, it could be that certain advertising needed to be enhanced at a particular server that could be directed toward that particular area of the country. If such were the case, a message could be formulated and transmitted thereto.

Referring now to FIG. 10, there is illustrated a diagrammatic view of an alternate embodiment in the present disclosure, wherein multiple aggregate databases are provided. In the embodiment of FIG. 10, there are provided three vendors, V1, as indicated by block 1002, V2, as indicated by block 1004 and V3, indicated by block 1006, all interfaced with the GCN 108. Each of the vendors 1002 1006 are associated therewith a separate customer base (which could overlap), indicated respectively by blocks 1008, 1010 and 1012. Therefore, each of the vendors would interface with their particular customer base to conduct commercial transactions therewith and to update their associated vendor databases (not shown). The analysis site 118 has associated therewith a plurality of aggregate databases, a database 1014 associated with vendor V1, an aggregate database 1016 associated with vendor V2 and an aggregate database 1018 associated with a vendor V3. This would be a normal operation, wherein analysis site 118 and the associated service provider would have multiple customers. However, in aggregating the data, it is possible for the analysis site 118, having access to all of the data of the various vendors, to determine certain trends based upon statistical analysis of all of the databases 104-1018, i.e., analyzing data across the databases. This would then allow the analysis site 118 to create a multiple aggregate database 1020 and then provide information thereon. Of course, the aggregate databases 1014 1018 would be created in conjunction with enhanced information such as demographics and such extracted from the enhancing database 130. This would allow multiple trending operations to occur and would also provide a vendor with information that could not be directly extracted from their own associated database. Of course, there are some privacy issues that would have to be dealt with by the service provider at the analysis site 118 in handling data from different vendors.

Referring now to FIG. 11, there is illustrated a diagrammatic view of the overall statistical evaluation, indicated by block 1102. In general, parameters would be provided to statistical evaluation engine and also aggregates statistics. These aggregate statistics are those collected by the analysis site 118 from the vendor which statistics would then be evaluated in view of the parameters. The statistical evaluation engine 1102 could be as simple as a first principals engine which is basically a rule based system. This would be a situation wherein, if a certain trend in the aggregate statistics existed, which was indicated by the parameters, then a business decision would be made. This business decision is a function of the rules associated with the statistical evaluation engine 1102. Of course, this statistical evaluation engine could be an optimized system for providing an optimized business objective of some form or it could actually optimize the operation of the vendor's web site in interfacing with the various users.

Referring now to FIG. 12, there is illustrated a diagrammatic view of the operation wherein large amounts of data are retrieved from a vendor database 110. Vendor database 110 is a very large database and is associated with a plurality of web servers 1202. Each of these web servers 1202, there being “N” web servers 1202, interface with the GCN 108. The analysis site 118 is operable to run a plurality of fetch operations. These fetch operations allow multiple data to be obtained from the vendor database 110 in parallel. Each of the fetch operations is operable to partition a particular job—it could be a large job—to allow extraction of data from the vendor database 110. The extraction operation requires data transfer. Each of the web servers 1202 has a limited bandwidth associated therewith. This limitation of bandwidth is typically on the GCN side. However, the database side of each of the servers 1202 will typically have a considerably higher bandwidth and handle data transfer. Further, each fetch operation requires a certain amount of processing time at the vendor web server. This processing time is primarily involved with querying the database and reformatting or assembling the extracted data into an XML data stream and then transferring the data stream over the GCN 108. The actual querying operation is typically performed on a relatively high bandwidth data path and also is a very efficient operation, since it is typically done in the native language of the server. By partitioning a large job, the fetch operations will divide the data transfer operations among the web servers 1202. At the analysis site 118, this is not as large a problem, since the bandwidth on the GCN side of the analysis site 118 is fairly adequate or can be made adequate with additional equipment if necessary.

As an example of the fetch operation, consider a situation wherein a new user comes on line and wants to have a statistical analysis of their data on a pseudo real-time basis. If the first query is for current data or data less than a day or two old, the overall statistics will be rather limited. By having the capability to fetch old historical data from the vendor database 110, a more reliable statistical operation can be performed. However, in order to fetch a large amount of data associated with the historical operation of the vendor, this requires a large amount of data to be transferred. The configuration of FIG. 12 allows this to happen. For example, there could be provided a plurality of fetch operations 1208, each associated with a different range of data. One of the fetch operations 1208 could be associated with data over a range, for example, January and February of the prior year, a second fetch process associated with March and April, a third fetch process associated with May and June, and so on, until all of the data has been retrieved. This is an asynchronous fetch operation. This is a system that more easily facilitates the real-time aspect of statistical analysis of a dynamic database that is continuously changing and continually being updated with updated records or new records.

Referring now to FIG. 13, there is illustrated an operational diagram for forming the aggregate statistics at the analyzing site 118. As noted hereinabove, there is provided the vendor database 110 with a plurality of records disposed therein and the enhancing database 130. The vendor database 110 is operable to collect records and store these records for use at the vendor site 104. The disclosed system is operable to extract select ones of these records for the purpose of performing statistical analysis thereon. In the embodiment illustrated in FIG. 13, there are provided three records, R5, R6 and R7. These are the three records that are desirable for the purpose of performing a statistical analysis. Thus, these are the records that are selected by the system.

These vendor records, R5, R6 and R7, are output to a block 1302, which is operable to perform a summing operation with information in the enhancing database 130. As described hereinabove, this block 1302 represents the operation wherein data is requested from the vendor database 110, received therefrom and then corresponding data is requested from the enhancing database 130. As also described hereinabove, the manner in which the data is retrieved from the enhancing database 130 can basically be an operation wherein only a portion of the information from the records is sent to the enhancing database location and information extracted from the enhancing database 130 corresponding thereto then return to the block 1302. At the block 1302, the records R5, R6 and R7 are enhanced to provide the modified or enhanced records R5′, R6′ and R7′. This enhanced data is then utilized in a number of manners. First, it is stored in a raw database 1306 for use in possible later statistical calculations. However, in the current operation, i.e., that associated with the retrieved records, this enhanced data R5′, R6′ and R7′ is forwarded to a statistical calculator block 1308 which is operable to perform a predetermined statistical calculation thereon. This statistical calculation will then be input to the aggregate statistics database, a database 1310, for storage therein. This occurs at a time “n” which corresponds to the current calculation. However, in order to perform the statistical calculation in the calculator block 1308, there is required previous historical data, since the statistical calculation is based upon a large body of data (assuming that this is not the first calculation wherein the previous data would be “null”). The historical data that is extracted from the aggregate statistics database 1310 is extracted along a path 1312 representing the time “n−1.” This is input to the calculator block 1308 and the statistical operation is performed utilizing the previous historical data and the current data. By performing such a statistical calculation, the entire operation only requires a previous value or statistical result, i.e., the “n−1” result, and the current records as an update. This is essentially an update procedure. Interestingly enough, if the records are retrieved on a rather frequent basis, the extent of the calculation for each update is reduced. This improves the efficiency of the operation. Of course, if information is required by the user that requires use of prior historical data, then data from the raw database 1306 could be utilized. This operation is represented by a dashed line 1314 wherein data is extracted from the raw database 1306. This operation, of course, will involve more processing time due to the amount of data contained therein. This would involve an expanded operation where, for example, a user would desire a larger “range” of calculation than had previously been performed. For example, if a user were viewing statistics for the current year and maintaining only those statistics in an ongoing statistical calculation, then only the current records would be added to an aggregate statistics corresponding thereto. However, if the user decided that they would like to view a range of three years instead of two years previous to the current year, this would then require the calculator block 1308 to extract data from the raw database 1306 to perform the statistical calculation thereon. Further, the system has the ability to also extract this historical data from the vendor database 110, if the data does not already reside in the raw database 1306.

Referring now to FIG. 14, there is illustrated a diagrammatic view of an example of the statistical calculation. This is an example for total revenue. In this operation, a block 1402 represents the revenue value for the records R5′, R6′ and R7′ that has been extracted. This is inputted to the calculator block 1308 which is operable to calculate the total revenue which is basically the current revenue plus the previous revenue. The revenue is defined by a variable T_{R}. The prior statistically determined revenue is determined by the variable T_{R(n-1)}, and the current revenue is designated by the variable T_{R(R5′, R6′, R7′),} with the revenue calculation being defined as:

T_{R}=T_{R(R5′,R6′,R7′)}+T_{R(n-1)}

Once the information has been determined, it is passed through a delay block 1404 to the database 1310. Each time an additional set of records is incorporated, it is always added to the previous calculation in the aggregate database 1310.

Referring now to FIG. 15, there is illustrated a diagrammatic view of an embodiment wherein the monitor function 132 is performed utilizing a Personal Digital Assistant (PDA). In this operation, the GCN 108 is interfaced with a PDA ISP (Internet Service Provider) 1502. The PDA ISP 1502 provides a link between a PDA 1504 and the GCN 108. Typically, the PDAs 1504 can be either tethered or operating on a wireless link. This is represented by a communication link 1506. However, it should be understood that any type of link between a PDA, typically some type of hand held apparatus, can be incorporated, either tethered or wireless utilizing any form of such technologies. Of course, the wireless link could be an RF link, an infrared link or any type of optical link. This merely provides for a portable nature. Some of the PDAs 1504 can even utilize paging systems to transmit the data thereto. These PDAs 1504 can be in the form of pagers, personal computers, hand held computing devices, etc. The PDAs 1504 typically have some type of processing engine associated therewith and a display, such that the display can allow the user interface with the information that can be returned thereto. Typically, PDAs 1504 have a lower bandwidth link with the GCN 108 than, for example, a personal computer with a high speed data link. As such, sometimes, a concatenated level of information is transmitted thereto.

Referring now to FIGS. 16-21, there are illustrated screen shots for various functionalities that are provided to an individual that functions as the monitor 132. These screen shots are referred to “full” screen shots that would be provided at a fully functional PC, i.e., an input/output device that is interfaced to the GCN 108 through a relatively high speed data link.

In the embodiments of FIGS. 16-21, the screens represent various functional features that enhance the interfacing of the user with the statistical analysis results. They define who the customers are, what the customers are buying, where the customers are located, when the customers were shopping and the various chart configurations. All of these, of course, are defined from a statistical standpoint.

With specific reference to FIG. 16, there is illustrated a chart depicting the interface aspect to the user that defines the particular customers. This is referred to as the “who” chart. In this screen, there are provided a number of regions. The first region is a region 1602 that sets forth alphanumeric characters that define such things as the number of customers related to general time factors, the number of new customers in that group and the number of repeat customers. Also, there are various statistics associated with such things as age, primary income groups, primary occupation and the primary geographic locations. This information, of course, is the portion of the information that is provided by the enhancing database. In addition, statistics are provided in terms of how many of the customers are men, women, married or have children. On the right side of the chart, there is provided an area 1604 which provides a graphical interface to the user associated with the information that is contained in the aggregate statistical database 1310. In this particular chart, there are provided two graphical charts, a graphical chart 1606 that illustrates the number of customers for a current month, beginning at the first day of the month. This is segregated into three plots, one for total customers, one for repeat customers and one for new customers. A second chart 1608 is provided that sets forth the cumulative number of customers on a daily basis for the current month. This is set forth in terms of the total customers, the new customers and the repeat customers. There is provided a selection on the lower portion as an area 1610 which is operable to determine how the x-axis is plotted, i.e., on a daily basis for the current month, on a weekly basis for the current quarter or on a monthly basis for the year, and also on a daily basis for the previous month, on a weekly basis for the previous quarter and on a monthly basis for the previous year. This region 1610 allows the user to define how the information is organized back at the analysis site 118 and transmitted thereto, noting that the data is not actually transmitted to the monitor site 132 but, rather, the statistical results are transmitted in the disclosed embodiment. However, it is conceivable that some of the analysis could actually be performed at the monitor site 132 in a distributed manner, depending upon the requirements for the information calculation.

Referring now to FIG. 17, there is illustrated a chart depicting information regarding what customers are buying. This, again, is divided into two sections, a section 1702 relating to alphanumeric information regarding what products are being sold, profit associated with products, etc. A second section 1704 is associated with the graphical representation thereof. In the alphanumeric section 1702, there is provided information regarding the top selling products of the week and their rank, defining both the product and the revenue associated therewith, a region associated with the highest profit products for the week and a section associated with the top selling products. In the graphical section 1704, there is provided a pie chart 1706 that shows revenue per product group and a bar graph 1708 corresponding to the pie chart 1706. The pie chart 1706, in this example, is divided up into such things as back packs, fishing products, tennis products, ski products, boots, jackets and golfing products. There is also a region 1710 on a lower portion thereof that allows a user to determine whether the graphical interface is based upon a weekly basis, a monthly basis for the current week or month or on a weekly basis or a monthly basis for the prior week or month. In addition, there is provided a region 1712 for all of the user interfaces that provide revenue information regarding the day's revenue, weekly revenue and quarterly revenue in association with a bar chart therefor for the week.

Referring now to FIG. 18, there is illustrated a screen shot depicting the trends of the location of the buying customers. This, again, is divided into two sections, an alphanumeric section 1802 and a chart section 1804 for the graphical representation of the alphanumeric information in area 1802. In area 1802, there are provided three sections, a first section which indicates sales at the particular e-commerce site, i.e., for vendor site 104, a region for regional sales at the vendor site 104 and a region indicating the top revenue stores at all vendor sites for a given vendor. In the first region, the sales at the vendor's location are determined as a function of revenue and profit for the present day, the previous day, the present week, the previous week and the present month to date. The second region, that associated with regional sales, indicates revenue as a function of a particular region. Although not illustrated, the region could be set forth as defining any resolution of location in the disclosed embodiment, this is only provided as large regions such as the northeast, the midatlantic, the southeast, etc. However, with demographic data that is provided by the enhancing database 130, this could be resolved down to the state level, the city level and even the regional areas in a given city. The third section, that associated with the top revenue stores, indicates the revenue for a particular store in a particular region. With respect to the chart region 1804, there are provided two charts, a chart 1806 and a chart 1808. The chart 1806 is that associated with the revenue in profit with two graphs, one for revenue and one for profit, the upper one being for revenue and the lower one being for profit. The lower chart, the chart 1808, is that associated with cumulative revenue and profit as a function of the day of the week. Again, there is provided a region 1810 for allowing the user to select the x-axis range, i.e., on a daily basis for the particular month or for last month, on a weekly basis for the present or the previous quarter and on a monthly basis for the current year or for the previous year. Note that, when the user selects the different x-axis value, this is a configuration change. Also, it can be seen, for example in chart 1808, that the cumulative revenue and profit is provided on a lower graph for profit and an upper graph for revenue with the days of the week in the month that the revenue was calculated, this being a cumulative value. It is noted that the left side of the graph, at the x-axis value of zero, that the cumulative value is typically zero. As to the right side of the graph, this is reasonably current information that, while the user is viewing the graph, could actually change based upon update information that can continually be provided to the user at the monitor location 132.

Although not illustrated, the graph portion 1804 could reflect cumulative revenue and profit as a function of demographics. Although the alphanumeric section 1802 illustrates a total for the month, this could be broken down into a graph for each day, for each week, etc. In the original setup, the user can configure any manner of displaying the information, in addition to determining what is evaluated and even how it is evaluated.

Referring now to FIG. 19, there is illustrated a screen shot depicting the time that the customers are shopping. Again, this screen shot is divided into two sections, an alphanumeric section 1902 and a graphical section 1904. The alphanumeric section 1902 is provided with three regions, one indicating the days of the week the customers are shopping, one indicating the hour of the day that the customers are shopping and one indicating the day of the month that the customers are shopping. All three of these are divided into the maximum average revenue, the maximum average transactions and the maximum average cart revenues. In this manner, there is provided an indication of when the maximum traffic occurs, assuming some type of average purchase by an individual. The maximum average revenue is basically the day of the week having the highest average revenue wherein the hour of the day provides the hour having the maximum average revenue on a hour by hour basis.

The graphical section 1904 has provided therein two graphs, a first graph 1906 associated with the average number of customers per day as function of the day of the week and a second graph 1908 depicting the cumulative number of customers per day. The graph 1906 and the graph 1908 are associated with both quarterly data for the present quarter and quarterly data for the previous quarter. In the first graph 1906, the present quarterly data is on the left side of each day with the previous quarter data on the right side. The graph 1908 has both a bar graph and a line graph, the line graph having two graphs, the top one for the present quarter and the bottom one for the previous quarter. From these graphs, the viewer can determine information such as which day has the largest number of transactions and also can compare the number of customers on a given day with transactions to determine if certain days have more customers that spend less. Alternatively, by viewing such a chart, an individual monitoring an operation of a particular commercial site can be provided with important information. As an example, consider a vendor that desires to sponsor some type of promotion for an outside supplier. This promotion is initiated with advertising and the such on a particular day of the week. The commerce provider can then view the number of customers, in addition to the revenue, to indicate if there is a relatively immediate response to a given advertisement in terms of the number of customers and/or the amount of revenue. It may be that the commerce provider notices a distinct increase in the number of customers the day after the promotion is presented to the public. However, it may also be that the commerce provider notices from the statistical analysis of the commercial transactions that the revenue does not increase as much as the customers and the revenue may in fact decrease. This could be due to factors such as the promoted product drawing in customers that do not purchase other items at the vendor's site but only the particular promoted product. As such, the vendor can determine if carrying the promoted product is of commercial value. This is very similar to situations that have occurred many times in the past with conventional advertising, wherein an advertiser would pay an advertising firm a large sum of money to develop an award winning advertisement which, although receiving accolades from the advertising industry and the public in general, resulted in little or no sales or name recognition of the product. These advertisements, although very popular with the public, sometimes were pulled due to the fact that they were ineffective as to actually promoting the product or increasing the name value. This is the reason that information regarding various aspects of a commercial transaction on a relatively real time basis are important. Further, it is also important to view these in the context of historical data and to allow the user to effect or change the view of such things.

Referring now to FIG. 20, there is illustrated a screen shot depicting the operation wherein the custom charts can be determined or just the charts that are available for the user to implement in any of the graphical sections. This screen shot is comprised of both an alphanumeric section 2002 and a graphical section 2004. The graphical section basically includes the graphical section 1904 comprised of the graph 1906 and the graph 1908. Any alphanumeric section, there is provided an information section and a list section 2006. The list section indicates the charts that are available. These charts are basically generated by a “wizard” which is a program that assists the users in the creation of the chart by asking questions. Typically, this is a conventional chart building mechanism that defines the variables that are on the y-axis and the variables that are on the x-axis and the type of chart that is to be displayed and the number of graphs that will be incorporated on a single graph. This information is then sent back to the analysis site 118 to generate the data.

Referring now to FIG. 21, there is illustrated a screen shot depicting the alarm function. In this alarm function, the user is provided with the ability to send a message when a pre-defined event occurs. This is facilitated with the messaging template 124. Both the event that triggers the message and the content of the message and the type of message can be defined. The alarms that are provided in the current configuration are provided in a section 2002 that define the alarm condition and also sets forth who a response is to be sent to. It also sets forth the particular operation that is to be taken, i.e., to send an e-mail with a predefined message to a certain individual or to actually send the page, i.e., the screen shot. In addition, the individual is provided with the ability to add alarms. There is also provided a graphical section 2004 with a graph 2006 disposed therein to indicate information regarding the alarms that have been generated on a daily basis. This is mirrored in a graph 2008 indicating the particular alarm history on a given day, i.e., what alarm occurred and what type of alarm it was. Even the time of the alarm is set forth.

For example, there is one alarm, alarm 2010, that sets forth an alarm condition in which revenue is low for some reason. Suppose, for example, that there was a heavy snowfall and inclement conditions preventing individuals from shopping at the store. An expected revenue could be set in as a threshold, below which an alarm would be set off. By having such a feature as an alarm, a vendor would have knowledge of the fact that the revenue was low in the morning substantially proximate to the time of the alarm generating event, i.e., on a real time basis the vendor would be provided with information that sales were well below what they expected them to be. If this happened to be, for example, the day after Thanksgiving, this would provide a very strong indication to the vendor that their end of the year sales may be jeopardy and this would trigger certain decisions, i.e., immediately go into a deep discount mode of operation on the following day, decrease orders from suppliers, etc. These alarms can be very important in certain situations, which situations may result in other decisions.

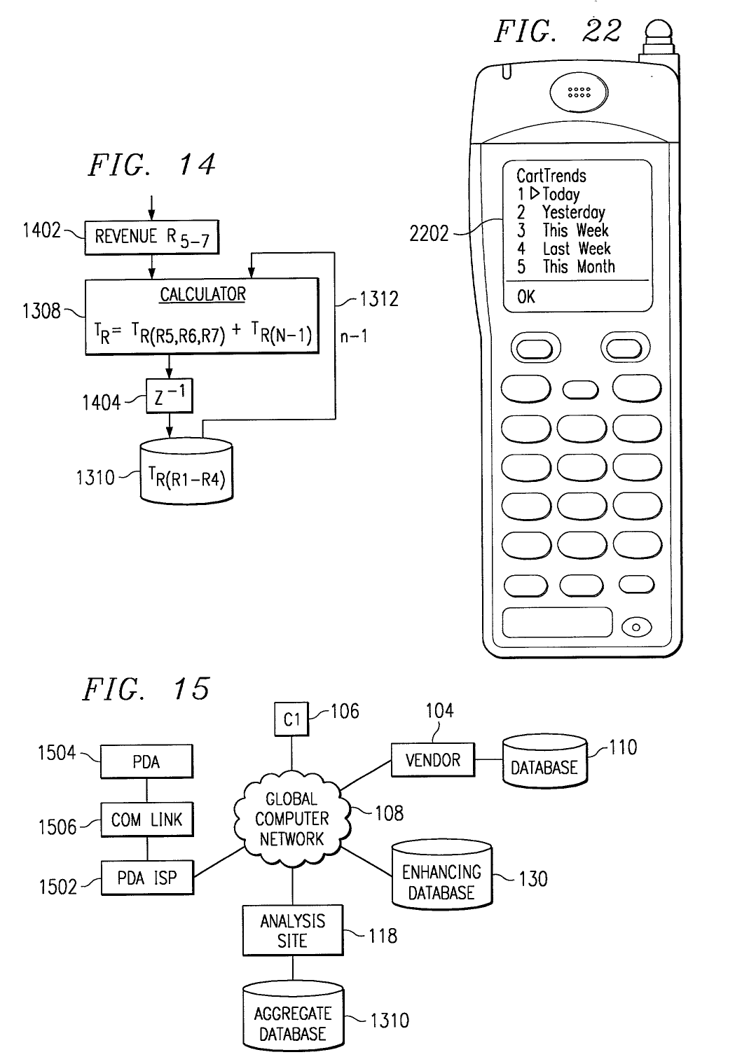

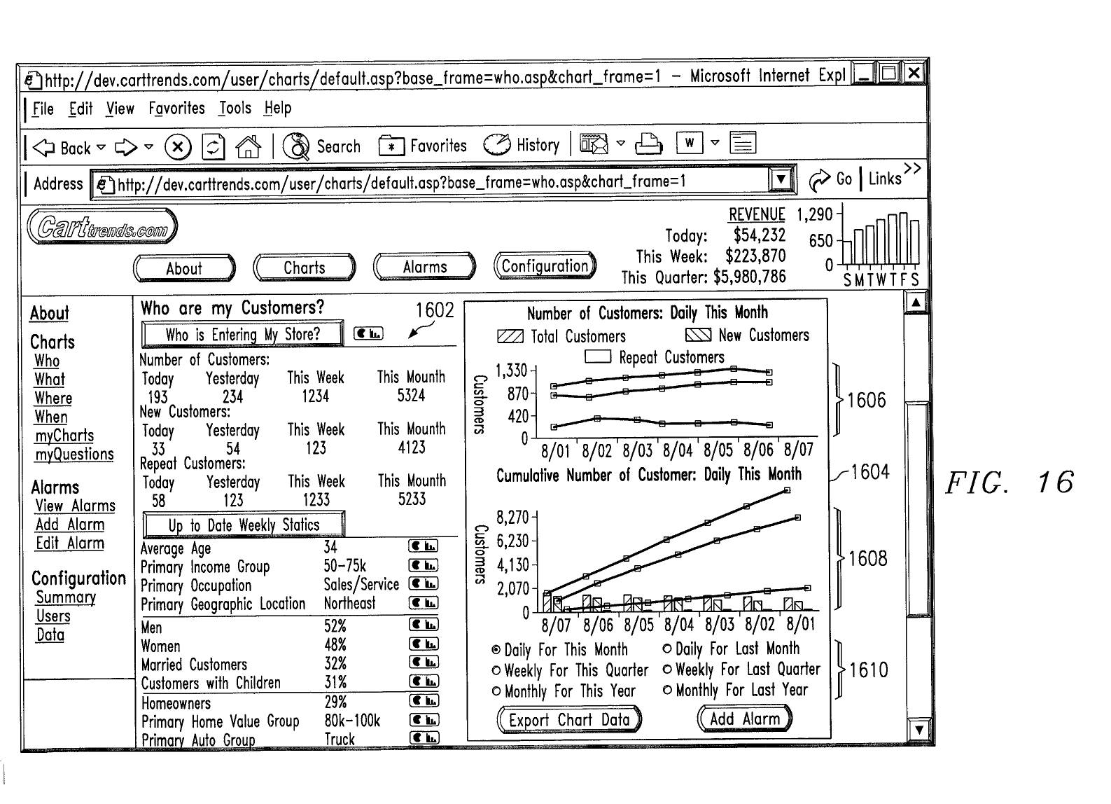

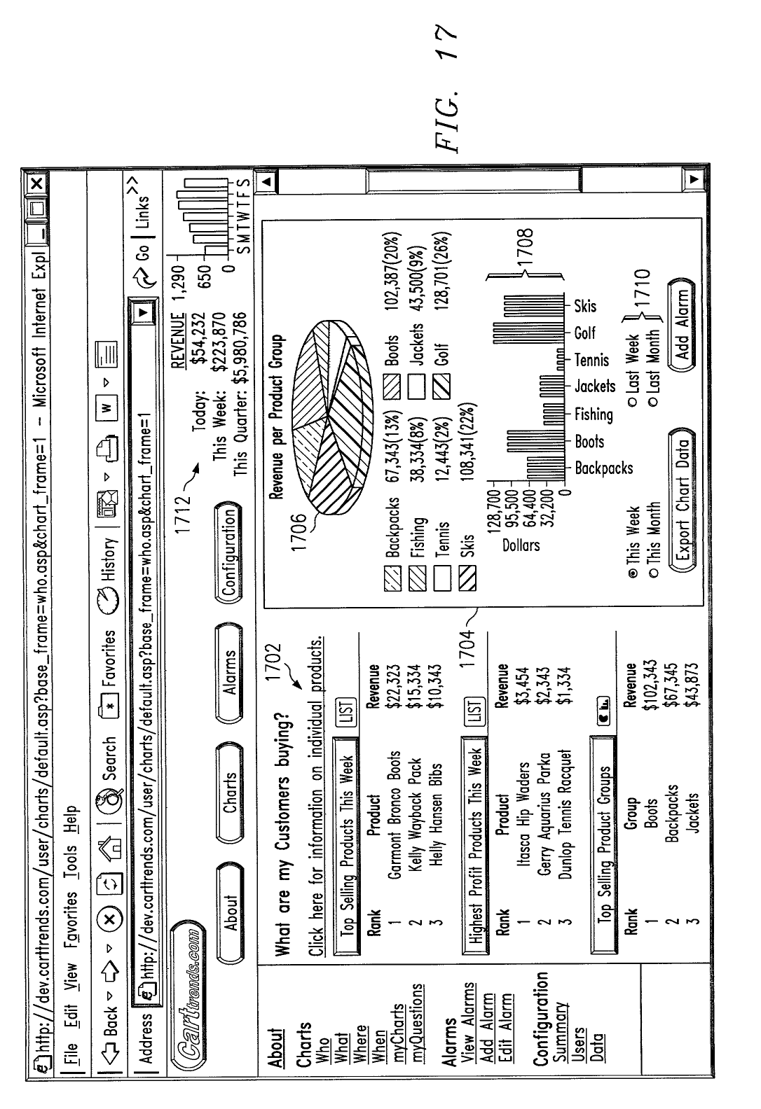

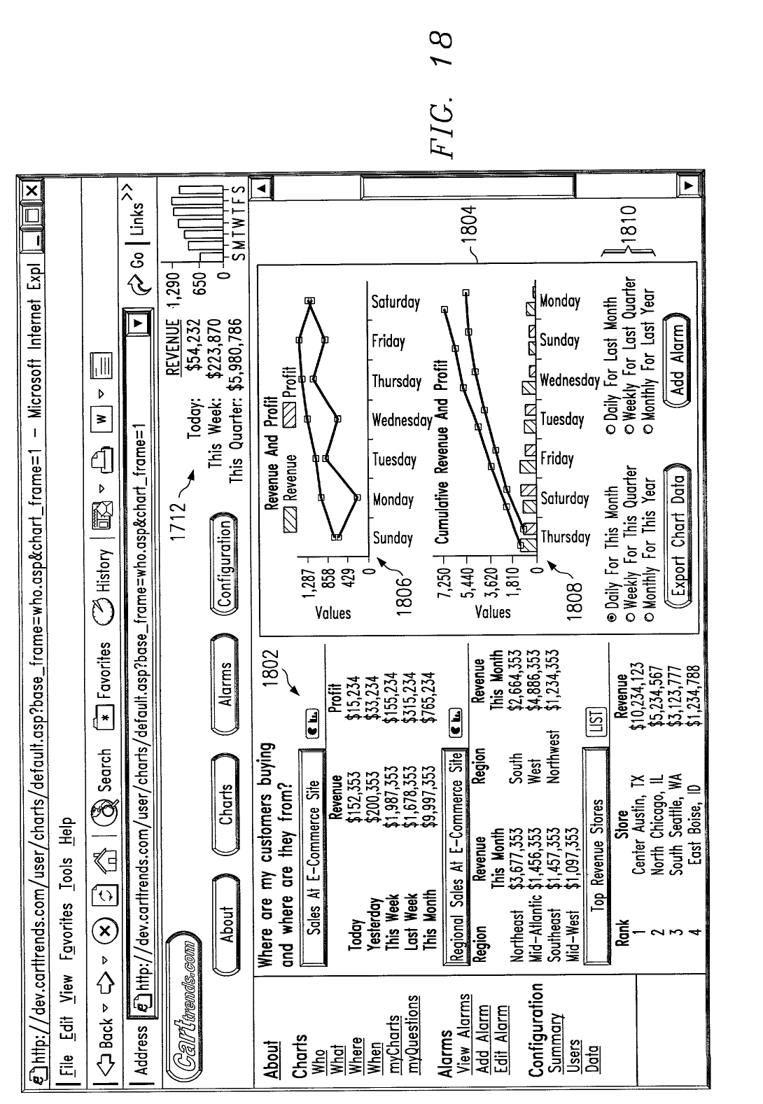

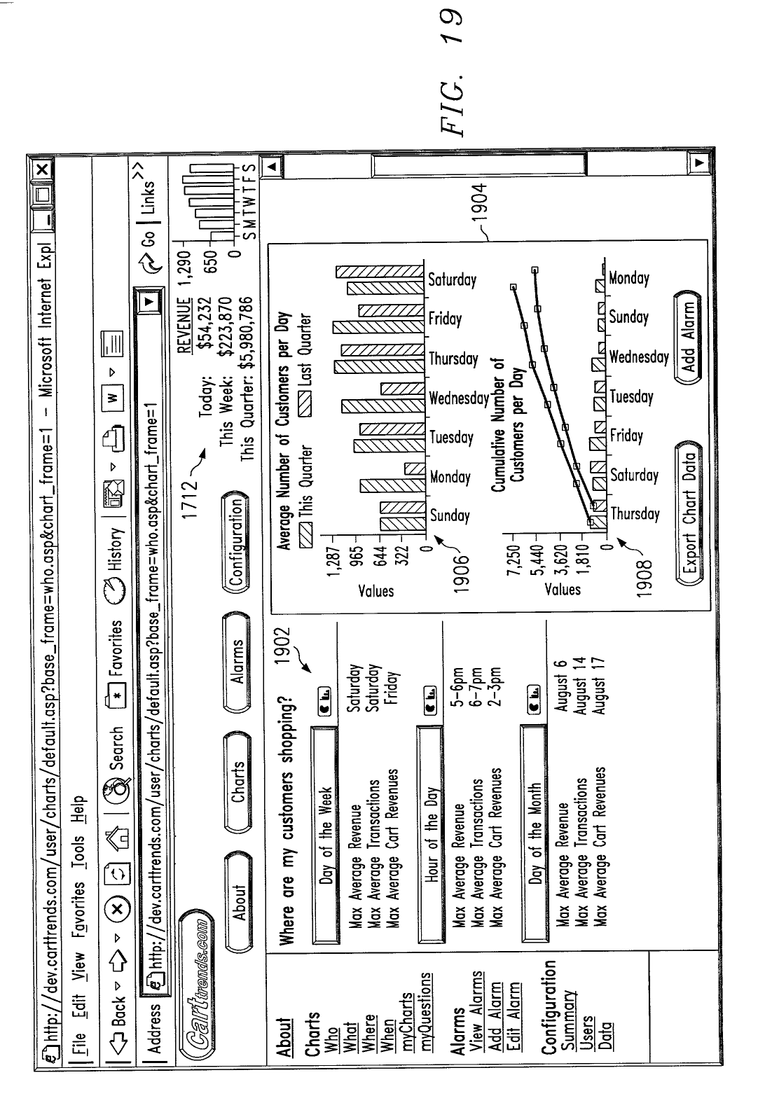

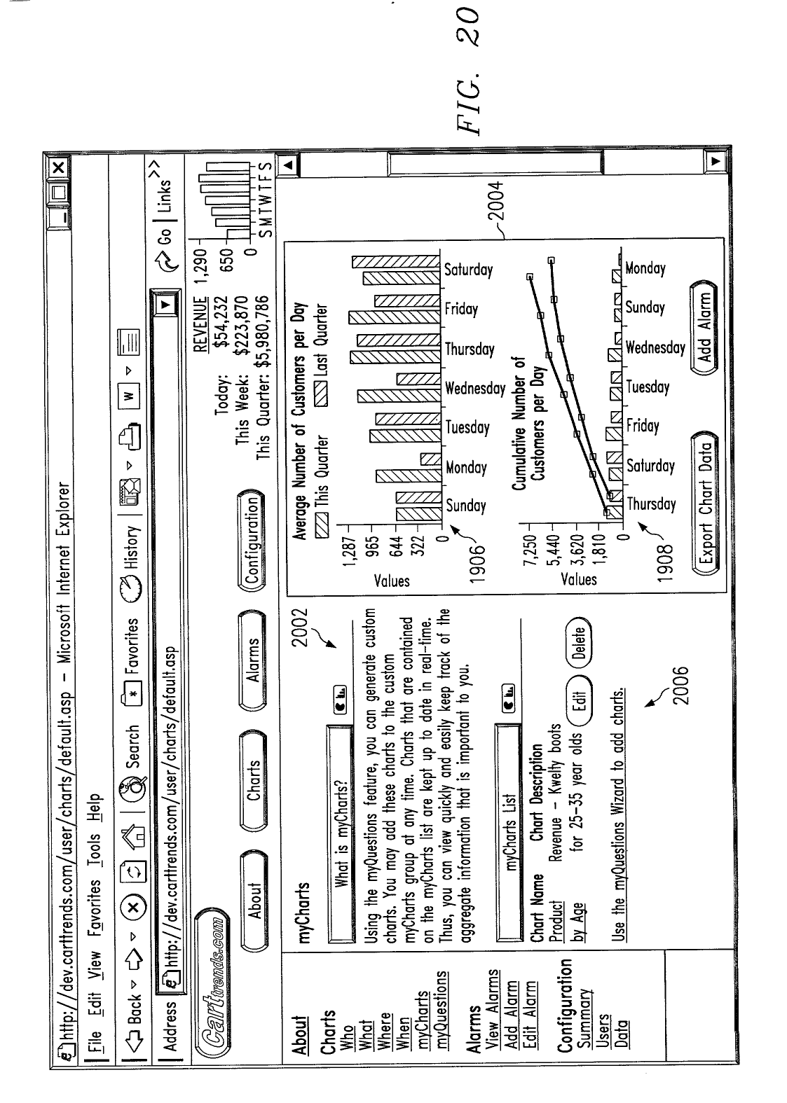

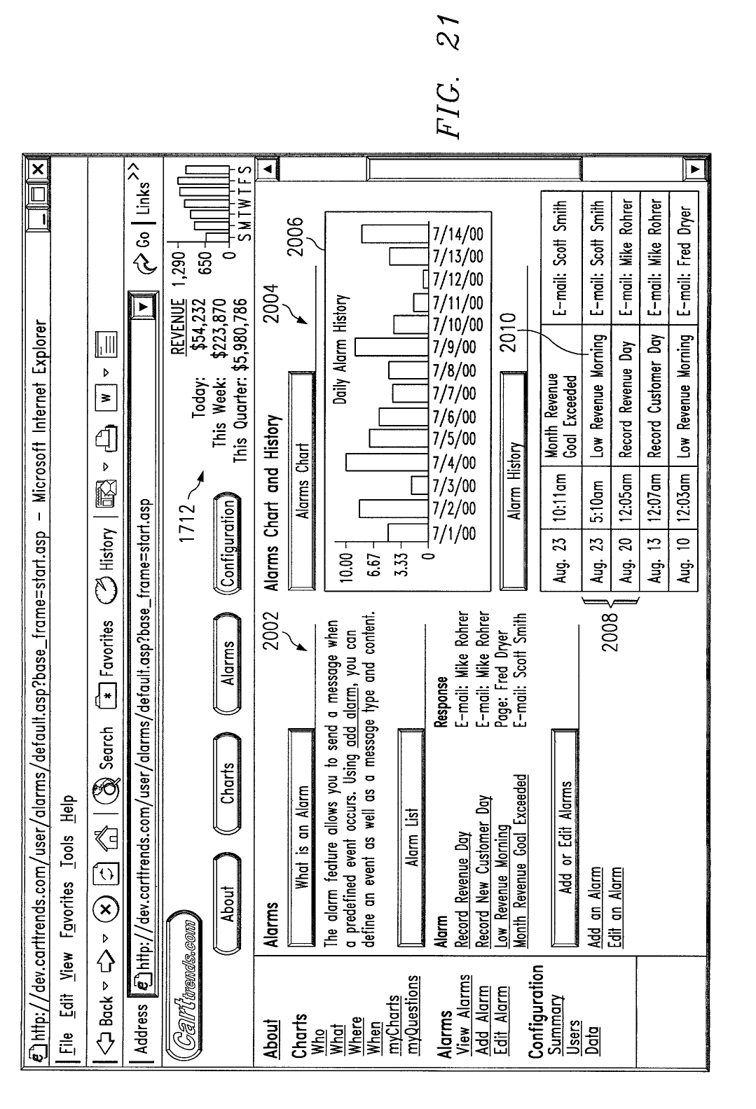

Referring now to FIG. 22, there is depicted a frontal view of a conventional PDA, in this situation a web access protocol (WAP) phone. The phone is provided with a display 2202, which display 2202 is operable to provide information to the user. Typically, this will not be the information that is provided on the screen shots depicted in FIGS. 17-21 but, rather, a concatenated version. For example, the first display might indicate a choice of terms such as “who,” “what,” “where,” “when” and “how much” and the selection of the “when” term might provide a display of the illustrated selections “today,” “yesterday,” “this week,” “last week” and “this month.” By selecting one of those terms, other information can be provided. This way, a user can obtain virtually real-time information regarding certain statistical trends in their commerce site.

Although the preferred embodiment has been described in detail, it should be understood that various changes, substitutions and alterations can be made therein without departing from the spirit and scope of the invention as defined by the appended claims.

What is claimed is:

1. A method for tracking analytical information acquired during consumer transactions, comprising the steps of:
conducting a commercial transaction between a customer and a vendor;
creating a record of each of the transactions conducted between the customer and the vendor;
storing the created record of the commercial transaction in a vendor transaction database;
retrieving the created record from the vendor transaction database;
retrieving from an enhancing database information relating to information retrieved from the vendor transaction database;
storing the combination of the retrieved records from the vendor transaction database and the retrieved information from the enhancing database as aggregate data in an aggregate database in a relational manner; and
performing an analysis on the aggregate data stored in the aggregate database in accordance with a predetermined analytical algorithm to provide an analytical result.

2. The method of claim 1, and further comprising the step of accessing the analytical result and displaying such accessed analytical result.

3. The method of claim 1, and further comprising the step of modifying the predetermined analytical algorithm.

4. The method of claim 1, wherein there are provided a plurality of records stored in the vendor transaction database.

5. The method of claim 4, wherein the step of retrieving comprises the step of retrieving a plurality of records from the vendor transaction database.

6. The method of claim 5, wherein the step of retrieving operates in response to receiving a request for one or more of the stored records in the vendor transaction database.

7. The method of claim 6, wherein the request comprises a fixed number of records.

8. The method of claim 6, wherein the request comprises a time range of records.

9. The method of claim 8, wherein the request comprises a date range of records.

10. The method of claim 6 and further comprising the step of modifying the request as a function of the number of commercial transactions being conducted.

11. The method of claim 5, wherein the step of retrieving operates in response to the creation of one or more of the records in accordance with predetermined criteria.

12. The method of claim 11, wherein the predetermined criteria comprises the receipt of a fixed number of records since the last retrieval step.

13. The method of claim 11, wherein the predetermined criteria comprises time criteria such that records are retrieved after a predetermined amount of time from a last retrieval operation.

14. The method of claim 11, wherein the predetermined criteria comprises date criteria such that the step of retrieving operates in accordance with predetermined dates.

15. The method of claim 11, wherein each record is retrieved upon creation thereof.

16. The method of claim 1, wherein the predetermined analytical algorithm comprises a statistical analysis algorithm and wherein the step of performing the analysis comprises statistically analyzing the aggregate data.

17. A method for analyzing transaction information in association with a plurality of commercial transactions between a plurality of customers and a vendor, comprising the steps of:
creating a transaction database of the commercial transactions between the plurality of customers and the vendor, which transaction database includes information relating to the transactions and the associated customers;
extracting a select portion of the transaction database and creating an intermediate aggregate database including information relating to the transactions and the associated customers;
interfacing with an enhancing database having demographic contained therein that is associated with the customers in the intermediate aggregate database;
extracting demographic information from the enhancing database corresponding to a select portion of the intermediate aggregate database for addition thereto that defines a new and aggregate database; and
performing a statistical analysis on the aggregate database in accordance with a predetermined statistical analysis algorithm to provide an statistical result.

18. The method of claim 17, and further comprising the step of accessing the statistical result and displaying such accessed statistical result.

19. The method of claim 17, and further comprising the step of modifying the predetermined statistical analysis algorithm.

20. The method of claim 17, wherein there are provided a plurality of records stored in the transaction database.

21. The method of claim 20, wherein the step of extracting a select portion of the transaction database comprises the step of retrieving a plurality of records from the transaction database.

22. The method of claim 21, wherein the step of retrieving operates in response to receiving a request for one or more of the stored records in the transaction database.

23. The method of claim 22, wherein the request comprises a fixed number of records.

24. The method of claim 22, wherein the request comprises a time range of records.

25. The method of claim 24, wherein the request comprises a date range of records.

26. The method of claim 22, and further comprising the step of modifying the request as a function of the number of commercial transactions being conducted.

27. The method of claim 20, wherein the step of retrieving operates in response to the creation of one or more of the records in accordance with predetermined criteria.

28. The method of claim 27, wherein the predetermined criteria comprises the receipt of a fixed number of records since the last extraction step.

29. The method of claim 27, wherein the predetermined criteria comprises time criteria such that records are extracted after a predetermined amount of time from a last extraction operation.

30. The method of claim 27, wherein the predetermined criteria comprises date criteria such that the step of extracting operates in accordance with predetermined dates.

31. The method of claim 27, wherein each record is extracted upon creation thereof.

32. A method for tracking analytical information acquired during commercial transactions between a plurality of customers and a vendor, which vendor is operable to create a record of each of the transactions conducted between the customer and the vendor and store the created record of the commercial transaction in a vendor transaction database, comprising the steps of:
retrieving the created record from the vendor transaction database;
retrieving from an enhancing database information relating to information retrieved from the vendor transaction database;
storing the combination of the retrieved records from the vendor transaction database and the retrieved information from the enhancing database as aggregate data in an aggregate database in a relational manner; and
performing an analysis on the aggregate data stored in the aggregate database in accordance with a predetermined analytical algorithm to provide an analytical result.

33. The method of claim 32, and further comprising the step of accessing the analytical result and displaying such accessed analytical result.

34. The method of claim 32, and further comprising the step of modifying the predetermined analytical algorithm.

35. The method of claim 32, wherein there are provided a plurality of records stored in the vendor transaction database.

36. The method of claim 35, wherein the step of retrieving the created record from the vendor transaction database comprises the step of retrieving a plurality of records from the vendor transaction database.

37. The method of claim 36, wherein the step of retrieving the created record from the vendor transaction database operates in response to receiving a request for one or more of the stored records in the vendor transaction database.

38. The method of claim 37, wherein the request comprises a fixed number of records.

39. The method of claim 37, wherein the request comprises a time range of records.

40. The method of claim 39, wherein the request comprises a date range of records.

41. The method of claim 37 and further comprising the step of modifying the request as a function of the number of commercial transactions being conducted.

42. The method of claim 36, wherein the step of retrieving the created record from the vendor transaction database operates in response to the creation of one or more of the records in accordance with predetermined criteria.

43. The method of claim 42, wherein the predetermined criteria comprises the receipt of a fixed number of records since the last retrieval step.

44. The method of claim 42, wherein the predetermined criteria comprises time criteria such that records are retrieved after a predetermined amount of time from a last retrieval operation.

45. The method of claim 42, wherein the predetermined criteria comprises date criteria such that the step of retrieving operates in accordance with predetermined dates.

46. The method of claim 42, wherein each record is retrieved upon creation thereof.

47. The method of claim 32, wherein the predetermined analytical algorithm comprises a statistical analysis algorithm and wherein the step of performing the analysis comprises statistically analyzing the aggregate data.

48. A method for monitoring commercial transactions at a vendor location, comprising the steps of:
accessing over a network a remote location therefrom;
retrieving trend data therefrom indicative of the commerce trends that occur at the vendor location; and
displaying the accessed trend data;
wherein, the trend data is comprised of commercial transaction data that represents record data of each transaction between the vendor at the vendor location and a customer that is enhanced with enhancing data different than the record data and the combined record data and enhancing data subjected to a predetermined trend algorithm to provide the trend data.

49. The method of claim 48, wherein the trend data is updated on a periodic basis.
